(19) United States
(12) Patent Application Publication
(10) Pub. No.: US 2017/0050371 A1
(43) Pub. Date: Feb. 23, 2017

(54) APPARATUS AND METHOD FOR APPLYING MULTI-COMPONENT ADHESIVES USING JETTING VALVES

(71) Applicant: Henkel IP & Holding GmbH, Duesseldorf (DE)

(72) Inventor: Steven J. Hemsen, Southington, CT (US)

(21) Appl. No.: 15/344,651

(22) Filed: Nov. 7, 2016

Related U.S. Application Data
(63) Continuation of application No. PCT/US15/29394, filed on May 6, 2015.
(60) Provisional application No. 61/988,937, filed on May 6, 2014.

(51) Int. Cl. B29C 65/48; B05C 9/06

(52) U.S. Cl. CPC B29C 65/485; B05C 9/06

(57) ABSTRACT

An apparatus and method for dispensing a multi-component adhesive using a pair of non-contact jetting valves. The multi-component adhesive is a combination of two or more individual reactive adhesive components, which are not adhesive by nature on their own, but which can be mixed to chemically react and form an adhesive. The individual reactive adhesive components are held and dispensed separately by the apparatus, such that the individual reactive adhesive components do not mix before they are deposited onto the target substrate.

### FIELD OF TECHNOLOGY

The present application relates to a method and apparatus for applying multi-component adhesives.

### BACKGROUND

Multi-component adhesives combine two or more individual adhesive components that are not adhesive by nature on their own, but which can be mixed to chemically react and form an adhesive. Commonly, on production lines, dispensing implements such as dynamic mix nozzles or static mix nozzles are used to mix and deliver multi-component adhesives onto substrates that are to be adhered together. However, mixing the individual adhesive components and causing them to chemically react before they are delivered onto a substrate presents a number of problems.

For instance, multi-component adhesives have a limited pot life, which is the amount time available after formation of the adhesive (i.e., mixing/reacting individual adhesive components) for applying the adhesive while still providing proper bond strength. Accordingly, the amount of time an already mixed multi-component adhesive is in a dispensing implement such as dynamic mix nozzles or static mix nozzles may negatively affect the bond strength of the adhesive. Further, because the chemical reaction of the individual adhesive components occurs inside a dispensing implement such as a dynamic mix nozzles or static mix nozzles, the dispensing implement must be thoroughly cleaned or disposed of after dispensation of the adhesive is complete. The cleaning of dispensing implements or the use of disposable dispensing implements may add significant costs to a manufacturing operation.

### SUMMARY

In one embodiment, a method for depositing a multi-component adhesive on a substrate comprises dispensing a first reactive adhesive component on a first substrate; dispensing a second reactive adhesive component on the first substrate; wherein the first reactive adhesive component and the second reactive adhesive component are dispensed separately; wherein the first reactive adhesive component and the second reactive adhesive component do not mix or chemically react with each other until deposited on the first substrate; and wherein the first reactive adhesive component is dispensed by a first jet valve and the second reactive adhesive component is dispensed by a second jet valve.

In some embodiments of the above method for depositing a multi-component adhesive on a substrate, the first reactive adhesive component and the second reactive adhesive component are dispensed as micro-volume deposits.

In some embodiments of any of the above methods for depositing a multi-component adhesive on a substrate, the first reactive adhesive component and the second reactive adhesive component are dispensed simultaneously.

In some embodiments of any of the above methods for depositing a multi-component adhesive on a substrate, the first reactive adhesive component and the second reactive adhesive component are dispensed sequentially.

In some embodiments of any of the above methods for depositing a multi-component adhesive on a substrate, the deposits of the second reactive adhesive component are dispensed to at least partially penetrate the deposits of the first reactive adhesive component.

In some embodiments of any of the above methods for depositing a multi-component adhesive on a substrate, the first reactive adhesive component and the second reactive adhesive component are dispensed in volumetric ratio of 1:1 or 2:1 through 10:1.

In some embodiments of any of the above methods for depositing a multi-component adhesive on a substrate, a first layer of the first reactive adhesive component is deposited on the first substrate and a second layer of the second reactive adhesive component is deposited on the first layer of the first reactive adhesive component

In some embodiments of any of the above methods for depositing a multi-component adhesive on a substrate, the deposits of the first reactive adhesive component and the deposits of the second reactive adhesive component are dispensed on the first substrate in an alternating pattern.

In some embodiments of any of the above methods for depositing a multi-component adhesive on a substrate, the deposits of the first reactive adhesive component and the deposits of the second reactive adhesive component differ in at least one of size, shape, or volume.

In some embodiments of any of the above methods for depositing a multi-component adhesive on a substrate, the deposits of the first reactive adhesive component and the deposits of the second reactive adhesive component have a volume of approximately 0.0005 ml to 0.01 ml.

In some embodiments of any of the above methods for depositing a multi-component adhesive on a substrate, the deposits of the first reactive adhesive component and the deposits of the second reactive adhesive component have a volume of approximately 0.001 ml to 0.002 ml.

In some embodiments of any of the above methods for depositing a multi-component adhesive on a substrate, the striking angle of the first jet valve on the first substrate and the striking angle of the second jet valve on the first substrate are not the same.

In some embodiments of any of the above methods for depositing a multi-component adhesive on a substrate, the first reactive adhesive component and the second reactive adhesive component are dispensed by non-touch-transfer onto the first substrate.

In some embodiments of any of the above methods for depositing a multi-component adhesive on a substrate, each of the first and second jet valves is separated from the first substrate by a separation distance.

In some embodiments of any of the above methods for depositing a multi-component adhesive on a substrate, the separation distance for each of the first and second jet valves is approximately between 0.05 inches to 0.5 inches.

In some embodiments of any of the above methods for depositing a multi-component adhesive on a substrate, the separation distance for each of the first and second jet valves is approximately between 0.25 inches to 0.5 inches.

Some embodiments of any of the above methods for depositing a multi-component adhesive on a substrate may further comprise providing a second substrate in relation to the first substrate so that the first reactive adhesive component and the second reactive adhesive component are between the first substrate and the second substrate; applying a force to move the first substrate and the second substrate together, such that the deposit of the first reactive adhesive component and the deposit of the second reactive adhesive component at least partially penetrate each other; and mixing the first reactive adhesive component and the second reactive adhesive component by vibrating the deposit of the first reactive adhesive component and the deposit of the second reactive adhesive.

In one embodiment, an apparatus for dispensing a multi-component adhesive comprises a first holding vessel for holding a first reactive adhesive component; a second holding vessel for holding a second reactive adhesive component; a first jet valve connected to the first holding vessel to dispense the first reactive adhesive component; and a second jet valve connected to the second holding vessel to dispense the second reactive adhesive component; wherein first and second holding vessels hold the first and second reactive adhesive components separately and the first and second jet valves dispense the first and second adhesive components separately, such that the first reactive adhesive component and the second reactive adhesive component do not mix or chemically react with each other until after dispensed from the apparatus.

In some embodiments of the above apparatus, the first and second jet valves are configured to dispense the first and second reactive adhesive components as micro-volume deposits.

In some embodiments of the above apparatus, the first and second jet valves are configured to dispense the first and second reactive adhesive components simultaneously.

In some embodiments of the above apparatus, the first and second jet valves are configured to dispense the first and second reactive adhesive components sequentially.

In some embodiments of the above apparatus, the first and second jet valves are configured to dispense the first and second reactive adhesive components such that the deposit of the second reactive adhesive component at least partially penetrates the deposit of the first reactive adhesive component.

In some embodiments of the above apparatus, the first and second jet valves are configured to dispense the first and second reactive adhesive components in a volumetric ratio of 1:1 or 2:1.

In some embodiments of the above apparatus, the first jet valve is configured to deposit a first layer of the first reactive adhesive component on the substrate; and the second jet valve is configured to deposit a second layer of the second reactive adhesive component on the first layer of the first reactive adhesive component.

In some embodiments of the above apparatus, the first and second jet valves are configured to dispense the deposit of the first reactive adhesive component and the deposit of the second reactive adhesive component on the substrate in an alternating pattern.

In some embodiments of the above apparatus, the first and second jet valves are configured to dispense the first reactive adhesive component and the second reactive adhesive component such that the deposit of the first reactive adhesive component and the deposit of the second reactive adhesive component differ in at least one of size, shape, or volume.

In some embodiments of the above apparatus, the first and second jet valves are configured to dispense the first reactive adhesive component and the second reactive adhesive component as deposits having a volume of approximately 0.0005 ml to 0.01 ml.

In some embodiments of any of the above apparatuses, the deposits of the first and second reactive adhesive components have a volume of approximately 0.001 ml to 0.002 ml.

In some embodiments of the above apparatus, the striking angle of the first jet valve on the substrate and the striking angle of the second jet valve on the substrate are not the same.

In some embodiments of the above apparatus, each of the first and second jet valves is separated from the substrate by a separation distance.

In some embodiments of the above apparatus, the separation distance for each of the first and second jet valves is approximately between 0.05 inches to 0.5 inches.

In some embodiments of the above apparatus, the first and second jet valves are configured to dispense the first and second reactive adhesive components by non-touch-transfer onto the substrate.

In some embodiments of any of the above apparatuses, the first and second jet valves are configured to dispense the first and second reactive adhesive components by non-touch-transfer onto a substrate.

In some embodiments, the above apparatuses further comprise a control unit for controlling the first and second jet valves in accordance with a defined operational parameter selected from the group consisting of dispensing volume, dispensing velocity, separation distance, striking angle, deposition speed and deposition pattern.

### BRIEF DESCRIPTION OF THE DRAWINGS

The foregoing summary, as well as the following detailed description of the exemplary embodiments, is better understood when read in conjunction with the appended drawings. For the purpose of illustrating the apparatuses and methods of the present application, exemplary embodiments are shown in the Figures; it being understood, however, that the present application is not limited to the specific embodiments disclosed. In the drawings:

FIGS. 1 and 2 are schematic drawings of an exemplary apparatus;

FIGS. 3-9 show exemplary deposition patterns of reactive components on a substrate;

FIG. 10 is a schematic drawing of two substrates bonded by a multi-component adhesive; and

FIG. 11 is a flow chart of an exemplary method.

### DETAILED DESCRIPTION

Before the various embodiments are described in further detail, it is to be understood that the present application is not limited to the particular embodiments described. It is also to be understood that the terminology used is for the purpose of describing particular embodiments only, and is not intended to limit the scope of the claims of the present application.

Provided is an apparatus 10 for dispensing a multi-component adhesive 12. The multi-component adhesive 12 is a combination of two or more individual reactive adhesive components 14, which are not adhesive by nature on their own, but which can be mixed to chemically react and form an adhesive. The individual reactive adhesive components 14 may be provided in combination with one or more non-reactive components and may be provided as fluids that can be delivered under pressure via jet dispending valves. The apparatus 10 holds and dispenses the individual reactive adhesive components 14 separately, such that the individual reactive adhesive components 14 do not mix before they are dispensed by the apparatus 10.

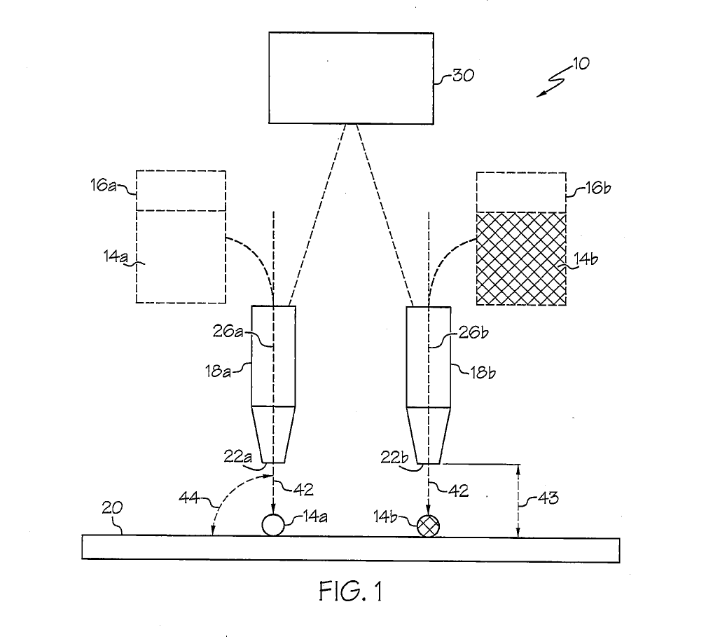

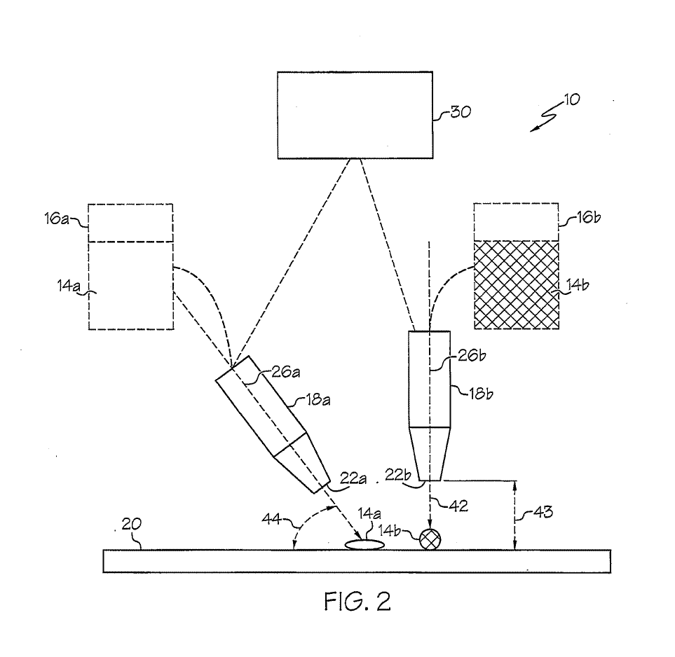

Referring to FIGS. 1 and 2, in one embodiment, the apparatus 10 may include a plurality of holding vessels 16 and a plurality of jet valves 18. Each of the holding vessels 16 contains only one of the individual reactive adhesive components 14, such that the individual reactive adhesive components 14 are held separately and are not mixed. Further, each of the jet valves 18 may dispense only one of the individual reactive adhesive components 14 so that the individual reactive adhesive components 14 are not mixed in the jet valves 18. For example, each of the jet valves 18 may be fluidly connected to one of the holding vessels 16 holding only one of the individual reactive adhesive components 14. The holding vessels 16 may be pressurized, for example, by air pressure, such that the individual reactive adhesive components 14 may be dispensed by the jet valves 18 under pressure. Although the holding vessel 16 and jet valve 18 corresponding to an individual reactive adhesive component 14 are shown as separate components, it will be apparent to those skilled in the art the holding vessel 16 and jet valve 18 corresponding to an individual reactive adhesive component 14 may be integrated into a single component. For example, the jet valve 18 may comprise the holding vessel 16 integrally formed therewith.

The jet valves 18 may dispense the individual reactive adhesive components 14 in micro-volume deposits (e.g., dots, beads or lines), such that when the individual reactive adhesive components 14 are dispensed onto a substrate 20, the individual reactive adhesive components 14 properly mix and react to form the multi-component adhesive 12. The jet valves 18 preferably dispense the individual reactive adhesive components 14 onto the substrate 20 using non-touch transfers, which allow the individual reactive adhesive components 14 to be deposited on the substrate 20 while maintaining the jet valves 18 at a distance from the substrate 20. Non-touch transfer allows faster deposition speeds, because it avoids having to place micro-volumes of the individual reactive adhesive components 14 on the substrate 20 while maintaining contact with the dispensing nozzle 22.

The jet valves 18 may be controlled to dispense the individual reactive adhesive components 14 in accordance with various defined operational parameters 24, including dispensing volume 41, dispensing velocity 42, separation distance 43, striking angle 44, deposition speed 45 and deposition pattern 46. The operation of the jet valves 18 and control of the various operational parameters 24 may be implemented using a computer control unit 30. The computer control unit 30 may have one or more computers, servers and/or devices featuring the necessary electronics, software, memory, storage, databases, firmware, logic/state machines, microprocessors, communication links, displays or other visual or audio user interfaces, printing devices, and any other input/output interfaces to provide any of the functions or services described herein and/or achieve the results described herein. The data and/or computer executable instructions, programs, firmware, software and the like (also referred to herein as “computer executable” components) for controlling the operation of the jet valves 18 and the various operational parameters 24, may be stored on a computer-readable medium that is within or accessible by the computer control unit 30, which when executed by a processor (such as a central processing unit, or CPU) of the computer control unit 30, cause the processor to perform all or a portion of the functions, services and/or methods described herein.

The dispensing volume 41 refers to the volume of the individual deposit of reactive adhesive component 14 (e.g., dot, bead or line) dispensed from the jet valve 18. The jet valves 18 are preferably controlled to dispense the individual reactive adhesive components 14 in micro-volume deposits (e.g., dots, beads or lines) to approximate mixing the reactive adhesive components 14 at the molecular level. By approximating mixing the reactive adhesive components 14 at the molecular level, chemical reaction of the reactive adhesive components 14 is improved, and thus bond strength of the multi-component adhesive 12 is also improved. For example, the jet valves 18 may be controlled to dispense the reactive adhesive components 14 in micro-volume deposits in the range of about 0.0005 ml to 0.01 ml, or more specifically in the range of about 0.001 ml to 0.002 ml.

Also, the jet valves 18 may be controlled to dispense the different individual reactive adhesive components 14 at different dispensing volumes 41 in order to accommodate different volumetric mixing ratios required by different multi-component adhesives 12. For example, for a multi-component adhesive 12 requiring a volumetric mixing ratio of 2:1 of a first individual reactive adhesive component 14a to a second individual reactive adhesive component 14b, a first jet valve 18a may be controlled to dispense the first individual reactive adhesive component 14a at a dispensing volume of 0.002 ml and a second jet valve 18b may be controlled to dispense the second individual reactive adhesive component 14b at a dispensing volume of 0.001 ml. Thus, if an equal number of micro-volume deposits (e.g., dots, beads or lines) of the first and second reactive adhesive components 14a, 14b are deposited on the substrate 20, then the appropriate 2:1 volumetric mixing ratio may be achieved.

The dispensing velocity 42 refers to the velocity of the reactive adhesive component 14 exiting the nozzle 22 of the jet valve 18. Each jet valve 18 may be controlled to dispense a reactive adhesive component 14 at a desired dispensing velocity 42 in order to control the collision energy of the reactive adhesive component 14 dispensed onto the substrate 20. Also, each jet valve 18 may be controlled to dispense the reactive adhesive component 14 at a desired dispensing velocity 42 in order to control the shape of the micro-volume deposits (e.g., dots, beads or lines) deposited on the substrate 20. Thus, each jet valve 18 may be controlled to control the collision energies and shapes of the reactive adhesive components 14 on the substrate 20 in order to promote the mixing and chemical reaction of the individual reactive adhesive components 14.

The separation distance 43 refers to the distance of the nozzle 22 of the jet valve 18 from the substrate 20. In order to perform non-touch transfers of the reactive adhesive components 14 onto the substrate 20, each jet valve 18 is maintained at a defined separation distance 43 from the substrate 20. For example, in some embodiments, the separation distance 43 may be in the range of 0.05 inches to 0.5 inches, or more specifically in the range of about 0.25 inches to 0.5 inches.

The striking angle 44 refers to the angle of a nozzle axis 26 of a jet valve 18 with respect to the substrate 20. Each jet valve 18 comprises a nozzle axis 26 along which reactive adhesive component 14 is expelled from the nozzle 22 of the jet valve 18. The striking angle 44 is the angle formed by the intersection of the nozzle axis 26 and the surface of the substrate 20. Each jet valve 18 may be controlled to dispense a reactive adhesive components 14 at a desired striking angle 44 in order to control the shape of the micro-volume deposits (e.g., dots, beads or lines) deposited on the substrate 20. The flatter the striking angle 44 of the jet valve 18, the more elongated the shape of the bead becomes; and the steeper the striking angle 44 of the jet valve 18, the more circular the shape the bead becomes. Thus, the jet valves 18 may be controlled to control the shapes of the reactive adhesive components 14 on the substrate 20 in order to promote the mixing and chemical reaction of the individual reactive adhesive components 14.

The deposition speed 45 refers to the frequency with which each jet valve 18 deposits the dots, beads or lines of a reactive adhesive component 14. In other words, the deposition speed 45 may be defined as the number of deposits of reactive adhesive component 14 per unit of time. Depending on the pot life of a multi-compound adhesive 12, it may be important to deposit the reactive adhesive components 14 on the substrate at a certain deposition speed 45 in order to avoid negatively affecting the bond strength of the multi-compound adhesive 12 that is deposited an mixed on the substrate 20.

The deposition pattern 46 refers to the manner in which the individual reactive adhesive compounds 14 are deposited with respect to one another on the substrate 20. In order to promote the mixing and chemical reaction of the individual reactive adhesive components 14 on the substrate 20, the individual reactive adhesive components 14 may be deposited on the substrate in various suitable patterns 46. For example, in some embodiments, the individual reactive adhesive components 14 may be deposited on the substrate 20 as micro-volume deposits (e.g., dots, beads or lines) in alternating patterns in order to ensure proper mixing and chemical reaction.

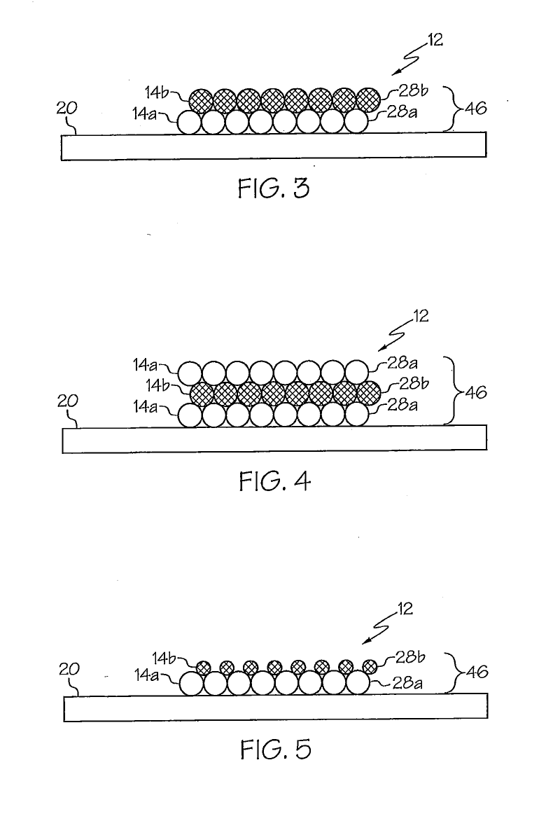

For example, as shown in the embodiments of FIGS. 3-5, the individual reactive adhesive components 14 may be deposited on the substrate 20 by the jet valves 18 in alternating layers 28. The exemplary embodiments of FIGS. 3-5 are described with reference to a two-component adhesive 12 comprising a first reactive adhesive component 14a and a second reactive adhesive component 14b. As shown in FIGS. 3-5, a layer 28a of the first reactive adhesive component 14a may be deposited on the substrate 20 and a layer 28b of the second reactive adhesive component 14b may be deposited on top of the layer 28a of the first reactive adhesive component 14a.

As shown in FIG. 3, there is one layer 28a of the first reactive adhesive component 14a and one layer 28b of the second reactive adhesive component 14b, so that there is a 1:1 volumetric mixing ratio of the first reactive adhesive component 14a to the second reactive adhesive component 14b. As shown in FIG. 4, there is one layer of the second reactive adhesive component 14b sandwiched between two layers of the first reactive adhesive component 14a, so that there is a 2:1 volumetric mixing ratio of the first reactive adhesive component 14a to the second reactive adhesive component 14b. Thus, as shown, the pattern of layers 28 of the reactive adhesive components 14 may be varied to establish different desired volumetric mixing ratios of the reactive adhesive components 14.

As shown in FIGS. 3-5, the layer of the first reactive adhesive component 14a and the layer of the second reactive adhesive component 14b may be deposited by the jet valves 18 as a series of micro-volume deposits (e.g., dots, beads or lines). FIG. 5, shows a layer 28a of beads of the first reactive adhesive component 14a deposited on the substrate 20 and a layer 28b of beads of the second reactive adhesive component 14b deposited on top of the layer 28a of the first reactive adhesive component 14a. The deposition of the beads of the second reactive adhesive component 14b on top of the beads of the first reactive adhesive component 14a promotes mixing and chemical reaction. In particular, various parameters 24, including dispensing velocity 42 and striking angle 44, may be controlled to cause the beads of the second reactive adhesive component 14b to at least partially penetrate the beads of the first reactive adhesive component 14a.

Further, as shown in FIG. 5, the dispensing volumes 41 of the reactive adhesive components 14 may be varied to establish different desired volumetric mixing ratios of the reactive adhesive components 14. More particularly, FIG. 5 shows that the beads of the second reactive adhesive component 14b have half the dispensing volume 41 of the beads of the first reactive adhesive component 14a, so that there is a 2:1 volumetric mixing ratio of the first reactive adhesive component 14a to the second reactive adhesive component 14b.

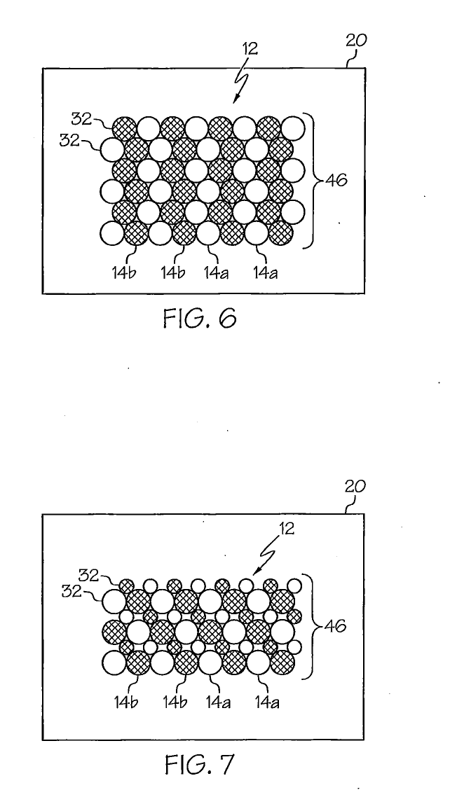

As shown in FIGS. 6-9, the individual reactive adhesive components 14 may alternatively be deposited on the substrate 20 by the jet valves 18 in one or more layers 28 comprising an alternating pattern of beads of a first reactive adhesive component 14a and beads of a second reactive adhesive component 14b. The exemplary embodiments of FIGS. 6-9 are described with reference to a two-component adhesive 12 comprising a first reactive adhesive component 14a and a second reactive adhesive component 14b. The deposition of the beads of the first reactive adhesive component 14a adjacent to the beads of the second reactive adhesive component 14b promotes mixing and chemical reaction. In particular, various parameters 24, including dispensing velocity 42 and striking angle 44, may be controlled to cause the beads of the first reactive adhesive component 14a and the beads of the second reactive adhesive component 14b to at least partially penetrate each other. Further, the beads of the first reactive adhesive component 14a and the beads of the second reactive adhesive component 14b may be dispense simultaneously or sequentially.

In one embodiment, as shown in FIGS. 6 and 7, a layer 28 comprising beads of the first reactive adhesive component 14a and beads of the second reactive adhesive component 14b is deposited on the substrate 20. The layer 28 comprises lines 32 comprising a series of alternating beads of the first reactive adhesive component 14a and beads of the second reactive adhesive component 14b. Accordingly, as shown, the beads of the first reactive adhesive component 14a are deposited adjacently to the beads of the second reactive adhesive component 14b. As shown in FIG. 7, the dispensing volumes 41 of the reactive adhesive components 14 may be varied to establish different desired volumetric mixing ratios of the reactive adhesive components 14. More particularly, FIG. 7 shows that the beads of the second reactive adhesive component 14b have half the dispensing volume 41 of the beads of the first reactive adhesive component 14a, so that there is a 2:1 volumetric mixing ratio of the first reactive adhesive component 14a to the second reactive adhesive component 14b.

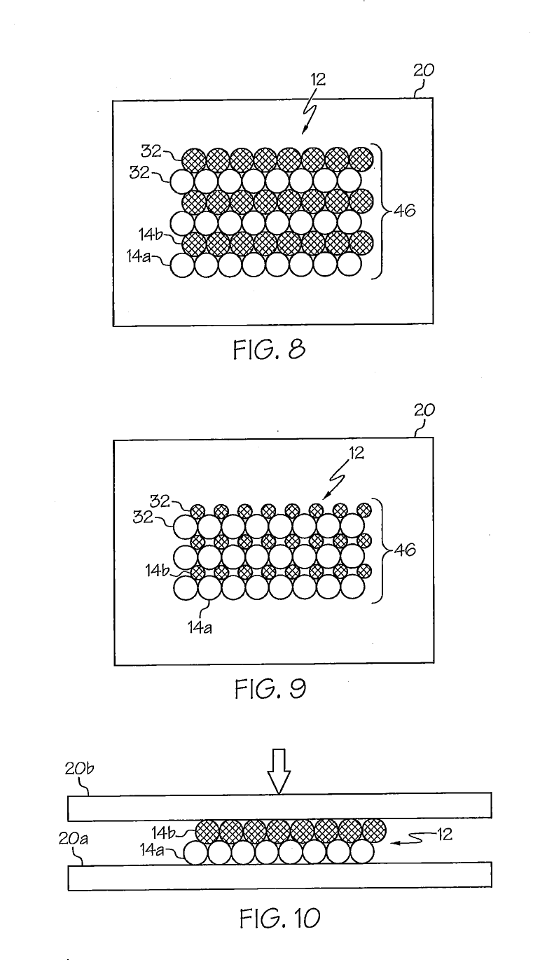

In another embodiment, as shown in FIGS. 8 and 9, the layer 28 comprises one set of lines 32a comprising a series of beads of the first reactive adhesive component 14a and another set of lines 32b comprising beads of the second reactive adhesive component 14b. As shown, the lines 32a of beads of the first reactive adhesive component 14a are deposited adjacently and alternatingly with the lines 32b of beads of the second reactive adhesive component 14b. As shown in FIG. 9, the dispensing volumes 41 of the reactive adhesive components 14 may be varied to establish different desired volumetric mixing ratios of the reactive adhesive components 14. More particularly, FIG. 9 shows that the beads of the second reactive adhesive component 14b have half the dispensing volume 41 of the beads of the first reactive adhesive component 14a, so that there is a 2:1 volumetric mixing ratio of the first reactive adhesive component 14a to the second reactive adhesive component 14b.

In some embodiments, mixing and chemical reaction of the individual reactive adhesive components 14 may be promoted by optimizing the collision energy associated with dispensing the individual reactive adhesive components 14 onto the substrate 20. As discussed above, certain parameters 24, including dispensing volume 41, dispensing velocity 42 and striking angle 44, may be varied to control the collision energy to cause the beads of the first reactive adhesive component 14a and the beads of the second reactive adhesive component 14b to at least partially penetrate each other. In some embodiments, the dispensing velocity 42 may be a max-min-splash velocity. The max-min-splash velocity is the velocity that creates the highest collision energy while not exceeding a specified acceptable level of splash of the reactive adhesive components 14 when dispensed by the jet valves 18 onto the substrate 20.

In accordance with another aspect of the present application, mixing and chemical reaction of the individual reactive adhesive components 14 may be further promoted after deposition on the substrate 20. Referring to the embodiment of FIG. 10, mixing of the reactive adhesive components 14 may be achieved by depositing the multi-component adhesive 12 between a first substrate 20a and a second substrate 20b, and applying a force to move the first substrate 20a and the second substrate 20b together, such that the beads of the first reactive adhesive component 14a and the beads of the second reactive adhesive component 14b at least partially penetrate each other. Still referring to FIG. 10, in some embodiments, mixing of the reactive adhesive components 14 may be achieved by vibrating the beads of the first reactive adhesive component 14a and the beads of the second reactive adhesive component 14b, which can be achieved by vibrating the first substrate 20a and/or the second substrate 20b. In some embodiments, vibration may be achieved by ultrasonic means, mechanical means or other suitable means.

In accordance with another aspect of the present application, provided is a method 50 implementing the apparatus 10 for dispensing a multi-component adhesive 12 and bonding two substrates together. The method 50 includes steps for depositing a first reactive adhesive component 14a and a second reactive adhesive component on a first substrate 20a so that the first and second reactive components 14a, 14b mix and chemically react to form a multi-component adhesive 12, which can be used to bond the first substrate 20a to a second substrate 20b.

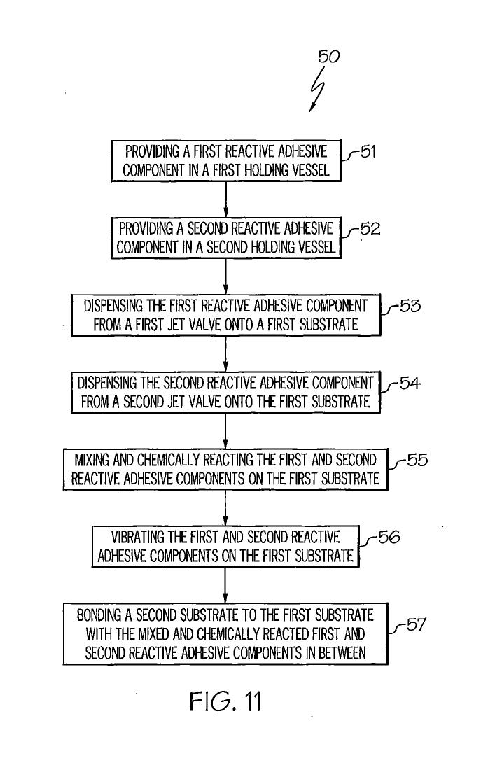

As shown in the exemplary embodiment of FIG. 11, the method 50 may comprise steps 51, 52 of providing a first reactive adhesive component 14a in a first holding vessel 16a and separately providing a second reactive adhesive component 14b in a second holding vessel 16b. The first and second reactive adhesive components 14a, 14b may be provided in the apparatus 10 described above. The apparatus 10 holds the individual reactive adhesive components 14a, 14b separately, such that the individual reactive adhesive components 14a, 14b do not mix before they are dispensed by the apparatus 10. The apparatus 10 comprises separate holding vessels 16a, 16b, where each of the holding vessels 16a, 16b contains only one of the individual reactive adhesive components 14a, 14b, such that the individual reactive adhesive components 14a, 14b are held separately and are not mixed.

The method 50 may further comprise steps 53, 54 of dispensing the first reactive adhesive component 14a with a first jet valve 18a of the apparatus 10 and separately dispensing the second reactive adhesive component 14b with a second jet valve 18b of the apparatus 10. The apparatus 10 dispenses the individual reactive adhesive components 14 separately, such that the individual reactive adhesive components 14 do not mix before they are dispensed by the apparatus 10. Accordingly, each of the jet valves 18 may dispense only one of the individual reactive adhesive components 14 so that the individual reactive adhesive components 14 are not mixed in the jet valves 18. Further, the jet valves 18 preferably dispense the individual reactive adhesive components 14 onto the substrate 20 using non-touch transfers, which allow the individual reactive adhesive components 14 to be deposited on the substrate 20 while maintaining the jet valves 18 at a distance from the substrate 20. Additionally, as discussed above, the jet valves 18 may be controlled to dispense the individual reactive adhesive components 14 in accordance with various defined operational parameters 24, including dispensing volume 41, dispensing velocity 42, separation distance 43, striking angle 44, deposition speed 45 and deposition pattern 46.

The method 50 may additionally comprise a step 55 of mixing and chemically reacting the individual reactive adhesive components 14 on the substrate 20. As discussed above, the jet valves 18 may be controlled to dispense the individual reactive adhesive components 14 in accordance with various defined operational parameters 24 that promote mixing and chemical reaction of the individual reactive adhesive components 14 on the substrate. For example, in order to promote the mixing and chemical reaction of the individual reactive adhesive components 14, the jet valves 18 may be controlled to control the collision energies, shapes and deposition patterns of the reactive adhesive components 14 on the substrate 20.

The method 50 may optionally comprise a step 56 of vibrating the individual reactive adhesive components 14 on the substrate 20 in order to promote the mixing and chemical reaction of the individual reactive adhesive components 14. Vibration may be achieved by ultrasonic means, mechanical means or other suitable means.

The method 50 may comprise a step 57 of bonding a second substrate to the first substrate with the mixed and chemically reacted individual reactive adhesive components 14.

Holding and dispensing the individual reactive adhesive components 14 separately, obviates the need to clean or dispose of the holding vessels 16 and jet valves 18. Preventing the mixing and chemical reaction of the individual reactive adhesive components 14 of the multi-component adhesive 12 before they are dispensed, preserves the pot life of the multi-component adhesive 12 and thus the bond strength of the multi-component adhesive 12. Non-touch transfer allows faster deposition speeds, because it avoids having to place micro volumes of the individual reactive adhesive components 14 on the substrate 20 while maintaining contact with the dispensing nozzle 22. By dispensing the individual reactive adhesive components 14 in micro-volume deposits (e.g., dots, beads or lines) and approximating mixing the reactive adhesive components 14 at the molecular level, chemical reaction of the reactive adhesive components 14 is improved, and thus bond strength of the multi-component adhesive 12 is also improved.

Although the apparatuses and methods of the present application have been shown and described with respect to detailed embodiments thereof, it will be understood by those skilled in the art that various changes in form and detail thereof may be made without departing from the spirit and the scope of the present application. With respect to the embodiments of the apparatuses described herein, it will be understood by those skilled in the art that one or more components may be added, omitted or modified without departing from the spirit and the scope of the present application. With respect to the embodiments of the methods described herein, it will be understood by those skilled in the art that one or more steps may be omitted, modified or performed in a different order and that additional steps may be added without departing from the spirit and the scope of the present application.

What is claimed is:

1. A method for depositing a multi-component adhesive on a substrate, comprising:
dispensing a first reactive adhesive component on a first substrate;
dispensing a second reactive adhesive component on the first substrate;
wherein the first reactive adhesive component and the second reactive adhesive component are dispensed separately;
wherein the first reactive adhesive component and the second reactive adhesive component do not mix or chemically react with each other until deposited on the first substrate; and
wherein the first reactive adhesive component is dispensed by a first jet valve and the second reactive adhesive component is dispensed by a second jet valve.

2. The method of claim 1, wherein the first reactive adhesive component and the second reactive adhesive component are dispensed as micro-volume deposits.

3. The method of claim 1, wherein the first reactive adhesive component and the second reactive adhesive component are dispensed simultaneously.

4. The method of claim 1, wherein the first reactive adhesive component and the second reactive adhesive component are dispensed sequentially.

5. The method of claim 1, wherein the deposit of the second reactive adhesive component are dispensed to at least partially penetrate the deposit of the first reactive adhesive component.

6. The method of claim 1, wherein the first reactive adhesive component and the second reactive adhesive component are dispensed in volumetric ratio of 1:1 or 2:1.

7. The method of claim 1, wherein a first layer of the first reactive adhesive component is deposited on the first substrate; and
wherein a second layer of the second reactive adhesive component is deposited on the first layer of the first reactive adhesive component.

8. The method of claim 7, wherein the mixing of the first reactive adhesive component and the second reactive adhesive component is augmented by vibrating the deposit of the first reactive adhesive component and the deposit of the second reactive adhesive.

9. The method of claim 1, wherein the deposit of the first reactive adhesive component and the deposit of the second reactive adhesive component are dispensed on the first substrate in an alternating pattern.

10. The method of claim 1, wherein the deposit of the first reactive adhesive component and the deposit of the second reactive adhesive component differ in at least one of size, shape, or volume.

11. The method of claim 1, wherein the deposit of the first reactive adhesive component and the deposit of the second reactive adhesive component have a volume of approximately 0.0005 ml to 0.01 ml.

12. The method of claim 1, wherein the striking angle of the first jet valve on the first substrate and the striking angle of the second jet valve on the first substrate are not the same.

13. The method of claim 1, wherein the first reactive adhesive component and the second reactive adhesive component are dispensed by non-touch-transfer onto the first substrate.

14. The method of applying adhesive of claim 1, wherein each of the first and second jet valves is separated from the first substrate by a separation distance.

15. The method of applying adhesive of claim 14, wherein the separation distance for each of the first and second jet valves is approximately between 0.05 inches to 0.5 inches.

16. The method of applying adhesive of claim 1, further comprising:
providing a second substrate in relation to the first substrate so that the first reactive adhesive component and the second reactive adhesive component are between the first substrate and the second substrate;
applying a force to move the first substrate and the second substrate together, such that the deposit of the first reactive adhesive component and the deposit of the second reactive adhesive component at least partially penetrate each other.

17. The method of applying adhesive of claim 16, wherein the mixing of the first reactive adhesive component and the second reactive adhesive component is augmented by vibrating the deposit of the first reactive adhesive component and the deposit of the second reactive adhesive.

18. An apparatus for dispensing a multi-component adhesive, comprising:
a first holding vessel for holding a first reactive adhesive component;
a second holding vessel for holding a second reactive adhesive component;
a first jet valve connected to the first holding vessel to dispense the first reactive adhesive component; and
a second jet valve connected to the second holding vessel to dispense the second reactive adhesive component;
wherein first and second holding vessels hold the first and second reactive adhesive components separately and the first and second jet valves dispense the first and second adhesive components separately, such that the first reactive adhesive component and the second reactive adhesive component do not mix or chemically react with each other until deposited onto a substrate.

19. The apparatus of claim 18, wherein the first and second jet valves are configured to dispense the first and second reactive adhesive components as micro-volume deposits.

20. The apparatus of claim 18, wherein the first and second jet valves are configured to dispense the first and second reactive adhesive components simultaneously.

21. The apparatus of claim 18, wherein the first and second jet valves are configured to dispense the first and second reactive adhesive components sequentially.

22. The apparatus of claim 18, wherein the first and second jet valves are configured to dispense the first and second reactive adhesive components such that the deposit of the second reactive adhesive component at least partially penetrates the deposit of the first reactive adhesive component.

23. The apparatus of claim 18, wherein the first and second jet valves are configured to dispense the first and second reactive adhesive components in a volumetric ratio of 1:1 or 2:1.

24. The apparatus of claim 18, wherein the first jet valve is configured to deposit a first layer of the first reactive adhesive component on the substrate; and
wherein the second jet valve is configured to deposit a second layer of the second reactive adhesive component on the first layer of the first reactive adhesive component.

25. The apparatus of claim 18, wherein the first and second jet valves are configured to dispense the deposit of the first reactive adhesive component and the deposit of the second reactive adhesive component on the substrate in an alternating pattern.

26. The apparatus of claim 18, wherein the first and second jet valves are configured to dispense the first reactive adhesive component and the second reactive adhesive component such that the deposit of the first reactive adhesive component and the deposit of the second reactive adhesive component differ in at least one of size, shape, or volume.

27. The apparatus of claim 18, wherein the first and second jet valves are configured to dispense the first reactive adhesive component and the second reactive adhesive component as deposits having a volume of approximately 0.0005 ml to 0.01 ml.

28. The apparatus of claim 18, wherein the striking angle of the first jet valve on the substrate and the striking angle of the second jet valve on the substrate are not the same.

29. The apparatus of claim 18, wherein each of the first and second jet valves is separated from the substrate by a separation distance.

30. The apparatus of claim 29, wherein the separation distance for each of the first and second jet valves is approximately between 0.05 inches to 0.5 inches.

31. The apparatus of claim 18, wherein the first and second jet valves are configured to dispense the first and second reactive adhesive components by non-touch-transfer onto the substrate.

32. The apparatus of claim 18, further comprising a control unit for controlling the first and second jet valves in accordance with a defined operational parameter selected from the group consisting of dispensing volume, dispensing velocity, separation distance, striking angle, deposition speed and deposition pattern.
